(19) United States
(12) Patent Application Publication
(10) Pub. No.: US 2023/0106931 A1
(43) Pub. Date: Apr. 6, 2023

(54) SWIVEL BLADE ASSEMBLY

(71) Applicant: Slice, Inc., Sunny Isles, FL (US)

(72) Inventor: Thomas Scimone, Sunny Isles, FL (US)

(21) Appl. No.: 17/493,471

(22) Filed: Oct. 4, 2021

(51) Int. Cl. B26B 5/00; B26B 9/00; B25G 3/38; B25G 3/10

(52) U.S. Cl. CPC B26B 5/00; B26B 9/00; B25G 3/38; B25G 3/10

(57) ABSTRACT

The present invention generally relates to swivel knives. Specifically, the present invention relates to blade assemblies comprising blades and blade retaining members, for example, blade cartridges for swivel knives.

### FIELD OF THE INVENTION

The present invention generally relates to swivel knives. Specifically, this invention relates to blade assemblies for swivel knives.

### BACKGROUND

Swivel blades are commonly used for carving or tooling materials such as leather. Standard swivel knifes comprise a metal swivel blade which is typically a unitary member having a cutting edge and a shank or post member configured to connect to a swivel knife handle. Metal knives can dull and wear out quickly, requiring frequent replacement and creating a safety hazard when users must apply significant force to adequately cut or carve materials. Ceramic knives have been developed to provide a safe and durable solution to these problems. However, a unitary ceramic swivel blade may be problematic, for example, because the tolerance of a ceramic shank member may be insufficient to retain a ceramic blade within the designated handle bore. Specifically, the tolerance between a ceramic shank or shaft member and an opening in a swivel handle bore may not be tight enough to retain the swivel blade within the handle, or the shank or shaft could be too large to fit into the bore of a handle.

Therefore, there is a need in the art for swivel blade assemblies which are replaceable, and which may adequately fit (e.g. tightly fit) into swivel blade bores, for example, standard swivel blade bores. These and other features and advantages of the present invention will be explained and will become obvious to one skilled in the art through the summary of the invention that follows.

### SUMMARY OF THE INVENTION

Accordingly, it is an aspect of the present invention to provide a cutting assembly having a ceramic cutting blade that is more durable and has increased wear resistance when compared to a standard cutting blade. Further, it is an aspect of the present invention to provide a cutting blade cartridge with a shank member configured to tightly fit within a swivel handle bore. In some scenarios, the shank member may provide a suitable tolerance range to fit and retain the swivel blade assembly within a swivel handle bore.

### BRIEF DESCRIPTION OF THE DRAWINGS

Accompanying this written specification is a collection of drawings of exemplary embodiments of the present invention. One of ordinary skill in the art would appreciate that these are merely exemplary embodiments, and additional and alternative embodiments may exist and still be within the spirit of the invention as described herein.

FIG. 1 is a perspective view of an exemplary swivel blade assembly having a straight edge in accordance with an embodiment of the present invention.

FIG. 2 is a top view of an exemplary swivel blade assembly having a straight edge in accordance with an embodiment of the present invention.

FIG. 3 is a side view of an exemplary swivel blade assembly having a straight edge in accordance with an embodiment of the present invention.

FIG. 4 is a perspective view of an exemplary swivel blade assembly having an angled edge in accordance with an embodiment of the present invention.

FIG. 5 is an exploded view of an exemplary swivel blade assembly in accordance with an embodiment of the present invention.

FIG. 6 is a perspective view of an exemplary swivel blade assembly connected to a swivel blade handle in accordance with an embodiment of the present invention.

### DETAILED SPECIFICATION

The present invention generally relates to swivel knives. Specifically, this invention relates to blade assemblies for swivel knives.

According to an embodiment of the present invention, a swivel knife blade assembly may comprise a blade and a blade retaining member, for example, a cartridge.

According to an embodiment of the present invention, the blade cartridge may have blade engagement portion and a handle engagement portion.

According to an embodiment of the present invention, a blade engagement portion of the blade cartridge may be a slot, recess or cavity configured to receive and retain at least a portion of a blade. In some examples, one or more walls of the blade engagement portion cavity may be configured to abut at least one exterior wall of the blade. In some examples, the walls may include one or more notches or indentations configured to engage with one or more protruding elements disposed on the exterior walls of the blade to secure the blade to the blade cartridge. Additionally or alternatively, one or more of the cavity walls may include one or more protrusions configured to engage with one or more notches or indentations disposed on the exterior walls of the blade to secure the blade to the blade cartridge. In some examples, one or more adhesive elements may be utilized to secure the blade to the blade cartridge. The adhesive elements may be, for example, glue, screws, pins or any other suitable permanent or releasable adhesives for securing a blade to a blade cartridge, depending on the intended utilization of the blade assembly.

In accordance with an embodiment of the present invention, a handle engagement portion of the blade cartridge may be a protruding member, for example, a post or shank member configured to connect to a knife handle, for example, a swivel knife handle. For example, a post or shank member of the blade cartridge may be configured to friction fit within a bore or opening in a swivel knife handle. In some scenarios, the blade cartridge may include one or more walls at the base of the post or shank, configured to abut one or more walls of a swivel blade handle about the circumference of the swivel handle bore.

According to an embodiment of the present invention, the blade retaining member may be a blade cartridge which may be provided for efficiently replacing a swivel blade. In some examples, a user may remove and replace an existing blade cartridge, for example, a used or dull blade or blade cartridge, with a new cartridge or to replace a blade cartridge for a blade cartridge having a blade chosen from a selection of blade profiles, including, for example, straight, angled, or other blade profiles.

According to an embodiment of the present invention, the blade cartridge may be adapted to provide a tolerance range needed to tightly fit the blade into a swivel blade handle bore or opening. In some examples, the blade cartridge shank may have a 0.5 mm diameter configured to tightly fit into a swivel blade handle bore or opening. In some scenarios, the blade cartridge and, specifically, the shank member of the blade cartridge, may be formed of a plastic material, for example, Acrylonitrile Butadiene Styrene (ABS), polycarbonate, polypropylene, or any other similarly suitable plastic, to provide tight tolerance within the swivel handle opening or bore. For example, a plastic shank member may provide tighter tolerance, for example, a tolerance of 0.2 mm or less, in the swivel handle opening or bore, than the tolerances achievable with a ceramic material which would have an approximate tolerance of about 1 mm within a swivel handle opening or bore,.

In any embodiment, the blade cartridge shank or shaft member may have predetermined dimensions and may be configured to fit (e.g. friction, sliding, or any other suitable fit) within a bore in any given swivel blade handle. In some scenarios, a set screw may be disposed 90 degrees from the cartridge shank or shaft to support the securement of the shank or shaft member within a swivel blade handle bore.

In some embodiments, the tight tolerance range provided by the shank member prevents the cartridge from inadvertently loosening or disengaging from the swivel handle bore.

In some embodiments, the shank or shaft member of the cartridge may be configured to be sized to fit within a bore of a swivel blade handle, for example, not too large or too small to fit into the swivel blade bore, while still providing a tight tolerance with in the swivel handle bored.

According to an embodiment of the present invention, the cutting edge of the blade may be straight or angled. In some scenarios, the cutting edge of the blade may be curved.

According to an embodiment of the present invention, the blade may be a durable ceramic blade that has increased wear resistance when compared to a standard cutting blade, for example, a metal cutting blade. The ceramic blade may also safer to use than standard metal cutting blades.

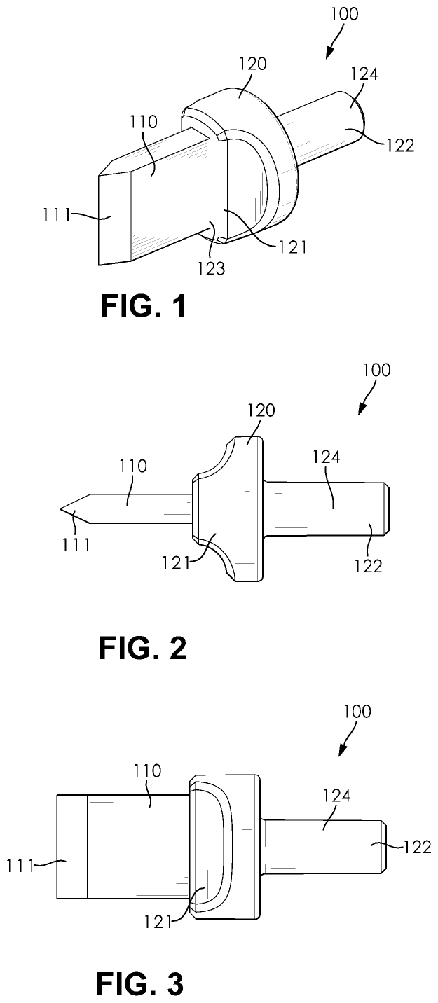

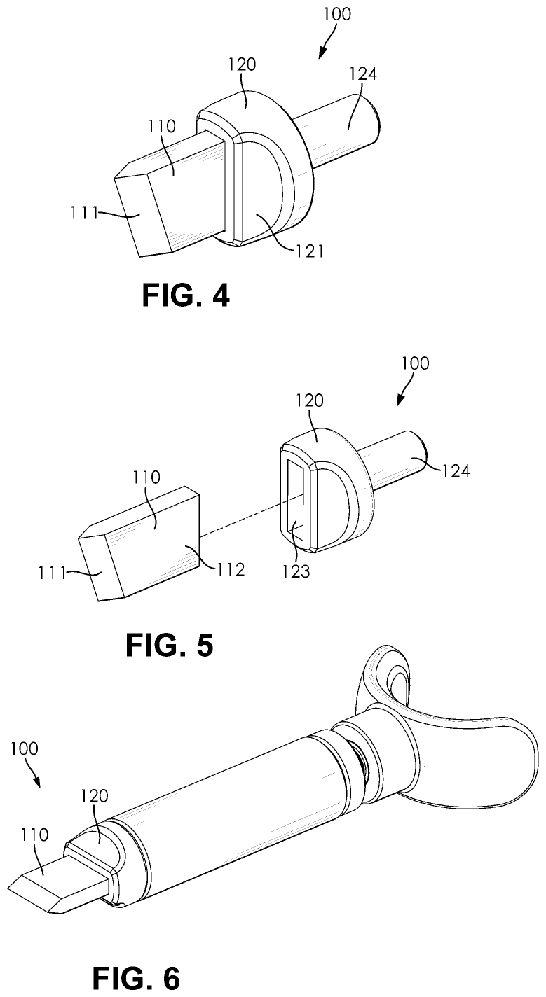

Turning now to the figures, FIG. 1 demonstrates a perspective view of an exemplary blade assembly. In the depicted example, the blade assembly 100 includes a blade 110 and a blade cartridge 120. The blade 110 may include a cutting edge 111. The cutting edge 111 may be configured as a straight edge (as demonstrated in FIGS. 1-3) or an angled edge (as demonstrated in FIGS. 4-5). The blade cartridge 120 may comprise a blade engagement portion 121 and a handle engagement portion 122. As shown in the illustrated example, the blade engagement portion 121 may comprise a recess or cavity 123 adapted to receive at least a portion of a blade 110. In some examples, one or more walls of the cavity 123 may be adapted to abut at least a portion of one or more walls of the blade 110. In some scenarios, the blade cartridge cavity 123 may be adapted to fit (e.g. friction, sliding, or any other suitable fit) at least a portion of the blade 110. In some embodiments, the handle engagement portion 122 may be a protruding member, for example, a post or shank member 124 configured to connect to a knife handle, for example, a swivel knife handle. For example, the post or shank member 124 may be configured to fit (e.g. friction, sliding, or any other suitable fit) within an opening in a swivel knife handle. In some scenarios, the blade cartridge 120 may include one or more walls at the base of the shank member 124, configured to abut one or more exterior walls of a swivel blade handle.

FIG. 2 depicts a top view of an exemplary swivel blade assembly in accordance with an embodiment of the present invention. As shown in FIG. 2, the blade 110 may be disposed within the blade cartridge 120. In some examples, the blade 110 may be removably disposed within a recess 123 in the blade cartridge 120. In some examples, the blade 110 may be permanently disposed within a recess 123 in the blade cartridge 120.

FIG. 3 depicts a side view of an exemplary swivel blade assembly in accordance with an embodiment of the present invention. As shown in FIG. 3, the shank member 124 may be a cylinder-shaped member, however, the shank member is contemplated to be formed in any similarly suitable three-dimensional shape, for example, rectangle, square, hexagon, or triangle shaped.

FIG. 4 is a perspective view of an exemplary swivel blade assembly having an angled edge in accordance with an embodiment of the present invention. In any embodiment, the blade 110 may have a first end with a sharp, cutting edge 111 longitudinally extending towards a second end with a flat (e.g. non-sharp) edge 112 (as shown in FIG. 5). As demonstrated by the drawings, the cutting edge 111 may be configured as a straight or angled edge. In any embodiment, the cutting edge 111 may have any suitable shape or profile, for example, straight, curved, angled, concave, or convex, depending on the intended use of the blade 110.

FIG. 5 depicts an exploded view of an exemplary swivel blade assembly in accordance with an embodiment of the present invention. As shown in FIG. 4, a blade assembly 100 may comprise a blade 110 and a blade cartridge 120. A recess 123 in the blade cartridge may be configured to receive at least a portion of the blade 110. In some examples, the blade 110 may friction fit in the recess 123. The blade 110 may additionally or alternatively be secured to the blade cartridge by any suitable means, including through the use of glue, screws, pins, tape or any other similarly suitable adhesives. The blade 110 may be configured to cut designated materials, for example, leather, and the blade cartridge 120 may be configured, in one respect, to retain the blade 110, and in a second respect, to releasably connect to a handle, for example, the bore of a swivel blade handle.

In some examples, the blade 110 may be formed of a first material, for example, a ceramic material, and the blade cartridge 120 may be formed of a second material, for example, a plastic material. In some scenarios, this configuration may limit the amount of ceramic material needed to create the swivel blade assembly.

In some examples, an adhesive or bonding material, for example, advanced epoxy, silicone, cyanoacrylate or UV cure adhesive systems, may be disposed between the blade 110 and the blade cartridge 120 to support securement of the blade 110 to the blade cartridge at a tight tolerance, for example, at a tighter tolerance than would be provided by a ceramic cartridge assembly.

In accordance with an exemplary usage scenario, the blade assembly 100 may be utilized to cut, carve or tool materials. As shown in FIG. 6, the blade cartridge 120 of the blade assembly 100 may connect to a blade handle. In some scenarios, the blade cartridge 120 may be removed or replaced as desired by a user. In some examples, a user may replace a worn or dull blade 110 with a new blade 110, as desired. For example, a user may disengage the cartridge 120 from the blade handle, for example, by pulling the shank member 124 from within the handle bore, and replace the blade 110 with a new blade 110, by replacing the blade cartridge 120 with a new blade cartridge 120.

According to an embodiment of the present invention, the ceramic cutting blades of the present invention may be constructed from a ceramic material that is capable of withstanding extended use without becoming dull or unusable. Ceramic materials appropriate for such construction include, but are not limited to, Zirconium Oxide. One of ordinary skill in the art would appreciate that there are numerous ceramic materials that could be utilized with embodiments of the present invention.

According to an embodiment of the invention, the blade cartridge or any parts thereof, may be formed from a suitable plastic or thermoplastic material, which may include, for example, Acrylanitrile Butadiene Styrene (ABS), Polycarbonate (PC), Mix of ABS and PC, Acetal (POM), Acetate, Acrylic (PMMA), Liquid Crystal Polymer (LCP), Mylar, Polyamid-Nylon, Polyamid-Nylon 6, Polyamid-Nylon 11, Polybutylene Terephthalate (PBT), Polycarbonate (PC), Polyetherimide (PEI), Polyethylene (PE), Low Density PE (LDPE), High Density PE (HDPE), Ultra High Molecular Weight PE (UHMW PE), Polyethylene Terephthalate (PET), PolPolypropylene (PP), Polyphthalamide (PPA), Polyphenylenesulfide (PPS), Polystyrene (PS), High Impact Polystyrene (HIPS), Polysulfone (PSU), Polyurethane (PU), Polyvinyl Chloride (PVC), Chlorinated Polyvinyl chloride (CPVC), Polyvinylidenefluoride (PVDF), Styrene Acrylonitrile (SAN), Teflon TFE, Thermoplastic Elastomer (TPE), Thermoplastic Polyurethane (TPU), Engineered Thermoplastic Polyurethane (ETPU), or any combination thereof.

It should be noted that the features illustrated in the drawings are not necessarily drawn to scale, and features of one embodiment may be employed with other embodiments as a skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A removably attachable blade assembly, comprising:
a blade; and
a blade cartridge having a blade engagement portion comprising a cavity adapted to receive the blade and a handle engagement portion comprising one or more protrusions adapted to releasably connect to a knife handle.

2. The removably attachable blade cartridge of claim 1, wherein the blade is a ceramic blade.

3. The removably attachable blade cartridge of claim 1, wherein the handle engagement portion is adapted to releasably connect the blade cartridge to a swivel blade handle.

4. The removably attachable blade cartridge of claim 3, wherein at least one of the protrusions is a shank member adapted to engage with a swivel handle bore.

5. The removably attachable blade cartridge of claim 4, wherein the shank member friction fits within the swivel handle bore.

6. The removably attachable blade cartridge of claim 5, wherein the shank member press or slide fits into the swivel handle bore.

7. A removably attachable blade assembly, comprising:
a ceramic blade having a first end with a cutting edge opposing a second end; and
a blade cartridge having a first side with a cavity adapted to receive the second end of the blade and a second side having one or more protrusions configured to releasably connect the blade cartridge to a knife handle.

8. The removably attachable blade assembly of claim 7, wherein the one or more protrusions of the blade cartridge are formed of a plastic material.

9. The removably attachable blade cartridge of claim 8, wherein at least one of the protrusions is a shank member adapted to engage with a swivel handle bore.

10. A removably attachable blade assembly, comprising:
a blade formed of a first material and having a first end with a cutting edge longitudinally extending towards a second end; and
a blade cartridge formed of a second material and having a first side with a cavity adapted to receive the second end of the blade and a second side having a shank member configured to releasably connect the blade cartridge to a knife handle bore.

11. The removably attachable blade assembly of claim 10, wherein the first material is a ceramic material.

12. The removably attachable blade assembly of claim 11, wherein the second material is a plastic material.

13. The removably attachable blade assembly of claim 10, wherein the cutting edge is straight.

14. The removably attachable blade assembly of claim 10, wherein the cutting edge is angled.

15. The removably attachable blade assembly of claim 10, one or more adhesive elements secure the blade to the blade cartridge.

16. The removably attachable blade cartridge of claim 10, wherein the shank member press fits into the swivel handle bore.

17. The removably attachable blade cartridge of claim 10, wherein the shank member slide fits into the swivel handle bore.
